(19) United States
(12) Patent Application Publication
(10) Pub. No.: US 2025/0062354 A1
(43) Pub. Date: Feb. 20, 2025

(54) METHOD FOR MANUFACTURING SELF-STANDING FILM FOR NEGATIVE-ELECTRODE OF LITHIUM SECONDARY BATTERY, AND SELF-STANDING FILM FOR NEGATIVE-ELECTRODE OF LITHIUM SECONDARY BATTERY

(71) Applicants: Hyundai Motor Company, Seoul (KR); Kia Corporation, Seoul (KR)

(72) Inventors: Byung Yong Lee, Anyang (KR); Dae Yang Oh, Hwaseong (KR); Hyun Jeong Kim, Suwon (KR)

(21) Appl. No.: 18/511,125

(22) Filed: Nov. 16, 2023

(30) Foreign Application Priority Data
Aug. 14, 2023 (KR) 10-2023-0106484

(51) Int. Cl. H01M 4/62; H01M 4/133; H01M 4/1393; H01M 10/0525

(52) U.S. Cl. CPC H01M 4/622; H01M 4/133; H01M 4/1393; H01M 10/0525; H01M 2004/027

(57) ABSTRACT

A method for manufacturing a self-standing film for a negative-electrode of a lithium secondary battery includes forming a negative-electrode active material layer in a film formation process using a composition for forming the negative-electrode of the lithium secondary battery, wherein the composition includes a negative-electrode active material, a conductive material, and a binder, wherein the binder includes a triblock copolymer having: a soft block derived from an aliphatic or cycloaliphatic diene-based monomer and having a rubber phase at room temperature; and a first hard block and a second hard block respectively connected to both ends of the soft block, and derived from an aromatic ring-containing ethylenically unsaturated monomer, and having a glass phase at the room temperature.

### CROSS-REFERENCE TO RELATED APPLICATION

This application claims the benefit of priority to Korean Patent Application No. 10-2023-0106484, filed in the Korean Intellectual Property Office on Aug. 14, 2023, the entire contents of which are incorporated herein by reference.

### TECHNICAL FIELD

The present disclosure relates to a method for manufacturing a self-standing film for a negative-electrode of a lithium secondary battery using a binder including a triblock copolymer containing a soft block and hard blocks, and a self-standing film for a negative-electrode of a lithium secondary battery manufactured using the method.

### BACKGROUND

Lithium secondary batteries have been widely applied in the portable electronic device market since their first commercialization in the 1990s, and continue to receive attention as the most researched energy storage system. Because of the characteristics of the lithium secondary batteries such as high operation voltage, high energy density, low self-discharge rate, high rate performance, and long cycle stability, lithium secondary batteries meet the appropriate requirements as an energy source for electric vehicles.

Nevertheless, the lithium secondary batteries applied to the electric vehicles face three major issues: safety, operating time, and cost. Issues of the safety and the operating time may be solved through all-solid-state batteries, but the cost acts as a factor preventing the widespread application of the lithium secondary batteries. Thus, much research is being conducted to reduce the cost of the lithium secondary batteries.

Reducing energy consumption required for manufacturing the lithium secondary batteries or increasing an electrode thickness is one of the most effective ways to reduce the manufacturing cost of lithium secondary batteries. Conventional electrode manufacturing technology forms an electrode by casting a slurry in which an electrode active material, a polymer binder, and a conductive additive are mixed with each other in water or an organic solvent onto a current collector, and drying and pressing the cast slurry. The energy required to prepare the slurry and coat the slurry onto the current collector accounts for about 50% of the energy consumed in the entire manufacturing process. In order to reduce the manufacturing cost of the lithium secondary batteries, research has been conducted on a process for manufacturing the electrode in a dry manner without the solvent.

Although much research has been conducted on the electrode manufacturing in the dry manner, a negative-electrode manufacturing scheme in a dry manner for manufacturing the negative-electrodes with good formability, good electrochemical stability, and good mechanical properties such as a tensile strength is underdeveloped. Thus, there is a need for research and development thereon.

### SUMMARY

In one aspect, a self-standing film suitable for a negative-electrode of a lithium secondary battery manufactured using a binder including a triblock copolymer containing hard blocks that contribute to excellent mechanical properties and a flexible soft block, such that the binder has good formability and is stable even at a negative potential level, and strongly binds to a negative-electrode active material and has excellent tensile strength and strongly binds to the negative-electrode active material and a conductive material to form a three-dimensional network, and provides a manufacturing method thereof, and provides a negative-electrode for a lithium secondary battery including the self-standing film, and provides a lithium secondary battery including the negative-electrode.

In one aspect, a method for manufacturing a self-standing film suitable for a negative-electrode of a lithium secondary battery is provided, the method comprising: a) forming a negative-electrode active material layer in a film formation process using a composition for forming the negative-electrode of the lithium secondary battery, wherein the composition comprises a negative-electrode active material, a conductive material, and a binder, wherein the binder includes a triblock copolymer comprising: i) a soft block derived from an aliphatic or cycloaliphatic diene-based monomer and having a rubber phase at room temperature; and ii) a first hard block and a second hard block connected to ends (e.g. opposing ends) of the soft block, and derived from an aromatic ring-containing ethylenically unsaturated monomer, and having a glass phase at room temperature (e.g. 25° C.), wherein the binder includes a plurality of particles each having an average diameter (D₅₀) in a range of 1 μm to 50 μm

According to an aspect of the present disclosure, a method for manufacturing a self-standing film for a negative-electrode of a lithium secondary battery includes forming a negative-electrode active material layer in a film formation process using a composition for forming the negative-electrode of the lithium secondary battery, wherein the composition includes a negative-electrode active material, a conductive material, and a binder, wherein the binder includes a triblock copolymer having: a soft block derived from an aliphatic or cycloaliphatic diene-based monomer and having a rubber phase at room temperature; and a first hard block and a second hard block respectively connected to both ends of the soft block, and derived from an aromatic ring-containing ethylenically unsaturated monomer, and having a glass phase at the room temperature, wherein the binder includes particles, each having an average diameter (D₅₀) in a range of 1 μm to 50 μm.

According to another aspect of the present disclosure, a self-standing film for a negative-electrode of a lithium secondary battery includes a negative-electrode active material layer including a plurality of domains of a negative-electrode active material, a plurality of domains of a conductive material, and a binder, wherein the binder includes a triblock copolymer having: a soft block derived from an aliphatic or cycloaliphatic diene-based monomer and having a rubber phase at room temperature; and a first hard block and a second hard block respectively connected to both ends of the soft block, derived from an aromatic ring-containing ethylenically unsaturated monomer, and having a glass phase at the room temperature, wherein the binder has a discontinuous pillar connecting one domain of the active material or one domain of the conductive material to another domain of the active material or another domain of the conductive material.

In one aspect, the binder of a self-standing film as disclosed herein suitably has a spherical shape, and an average sphericity thereof is in a range of 0.8 to 1.0.

In an aspect, in a self-standing film ad disclosed herein suitably each of first and second glass transition temperatures corresponding to the first hard block and the second hard block, respectively, is in a range of 50° C. to 120° C., wherein a third glass transition temperature corresponding to the soft block is in a range of −120° C. than −50° C.

In an aspect, in a self-standing film as disclosed herein suitably the soft block is derived from an aliphatic diene-based monomer including at least one selected from a group consisting of butadiene-based monomer, pentadiene-based monomer, and hexadiene-based monomer.

In an aspect, in a self-standing film as disclosed herein suitably each of the first hard block and the second hard block is independently derived from an aromatic ring-containing ethylenically unsaturated monomer including at least one of a styrene-based monomer and an aromatic (meth)acrylic-based monomer.

In an aspect, in a self-standing film as disclosed herein suitably the negative-electrode active material includes at least one selected from a group consisting of carbon-based active material, silicon-based active material, metal-based active material capable of being alloyed with lithium, and lithium-containing active material.

In an aspect, in a self-standing film as disclosed herein suitably the conductive material includes at least one selected from a group consisting of graphite, activated carbon, carbon black, acetylene black, Ketjen black, carbon nanotubes, graphene, and carbon fiber.

In an aspect, in a self-standing film as disclosed herein suitably may be prepared (including film formation process) in a dry manner (substantial absence of solvent).

In an aspect, in a self-standing film as disclosed herein suitably may be prepared (including film formation process) in a process includes calendaring, e.g. wherein the calendaring is performed at a temperature equal to or higher than a first glass transition temperature and a second glass transition temperature corresponding to the first hard block and the second hard block, respectively.

According to still another aspect of the present disclosure, a negative-electrode for a lithium secondary battery includes a current collector; and a self-standing film for the negative-electrode of the lithium secondary battery disposed on the current collector, wherein the self-standing film includes the self-standing film for the negative-electrode of the lithium secondary battery as defined above.

According to still another aspect of the present disclosure, a lithium secondary battery includes the negative-electrode for the lithium secondary battery; a positive-electrode for the lithium secondary battery; and an electrolyte.

In an aspect, provided is a negative electrode of a lithium secondary battery that includes the composition as described herein.

In an aspect, provided is a lithium secondary battery including the negative electrode as described herein.

In an aspect, provided is a vehicle including the lithium secondary battery as described herein.

The term “self-standing film or layer” or other similar term as used herein refers to a film, layer or sheet or the like in the form that can be handled as an independent layer without the assistance of a substrate or support. Thus, the term “self-standing” may have the same meaning as “self-supporting”.

A term “all-solid state battery” as used herein includes or refers to a rechargeable battery (including a secondary battery) that includes an electrolyte in a solid state, e.g., gel or polymer (cured), which may include an ionomer and other electrolytic components for transferring ions between the electrodes of the battery. In certain aspect, a lithium secondary battery as referred to herein is an all-solid state battery.

As referred to herein, a rubber phase or state is above the T_{g}, (glass transition temperature) of the material, i.e. where the material may be in a more rubbery state, and comparatively soft and flexible. Thus, when stated herein that the material forms a forming a rubbery phase at room temperature (e.g. 25° C.), the material may be above its glass transition temperature at room temperature (25° C.) and may in a comparatively rubbery or more flexible state.

As referred to herein, unless otherwise indicated, a glass phase or state is below the T_{g}, (glass transition temperature) of the material, and where the material may be in a more rigid or glassy configuration. Thus, when stated herein that the material forms a glass phase at room temperature (e.g. 25° C.), the material may be below its glass transition temperature at room temperature (25° C.) and may in a comparatively rigid or hardened state.

As referred to herein the term “block polymer” includes a polymer comprising two or more chemically distinct regions or segments (referred to as “blocks”) typically joined in a linear manner, e.g. a polymer comprising chemically differentiated units which are joined (covalently bonded) end-to-end with respect to polymerized functionality, rather than in pendent or grafted fashion. In one aspect, a block polymer may comprise (i) a first polymer block comprising at least 5, 10, 20 or 30 first repeating units; and (ii) a second polymer block comprising at least 5, 10, 20 or 30 second repeating units.

As referred to herein, the terms “soft block” and “hard block” indicate that the respective polymer units or portions differ in e.g. in structure and one or more properties. In certain aspects, the soft block may have a lower glass transition temperature or melting temperature (e.g. below room temperature) than a hard block (which may have a glass transition temperature or melting temperature higher (such as above room temperature) than the application temperature of the formed block copolymer material. In certain embodiments, the T_{g} of hard and soft blocks may differ by e.g. up to or more than e.g. 3° C., 5° C., 10° C., 20° C. or 30° C.

Other aspects of the invention are disclosed infra.

### BRIEF DESCRIPTION OF THE DRAWINGS

The above and other objects, features and advantages of the present disclosure will be more apparent from the following detailed description taken in conjunction with the accompanying drawings:

FIG. 1 is a schematic diagram showing an internal structure of a binder included in a self-standing film for a negative-electrode of a lithium secondary battery according to one embodiment of the present disclosure;

FIG. 2A is a schematic illustration of a method for manufacturing a self-standing film for a negative-electrode of a lithium secondary battery according to one embodiment of the present disclosure;

FIG. 2B is a diagram schematically showing a binder change mechanism during a manufacturing process of a self-standing film for a negative-electrode of a lithium secondary battery according to one embodiment of the present disclosure;

FIG. 3A to FIG. 3C shows SEM images of a self-standing film for a negative-electrode of a lithium secondary battery according to Present Example 1;

FIG. 3D shows a network structure composed of a binder and a negative-electrode active material in the self-standing film for the negative-electrode of the lithium secondary battery according to Present Example 1;

FIG. 3E and FIG. 3F show SEM images of SBS before manufacturing of the self-standing film for the negative-electrode of the lithium secondary battery and a composition (mixed powder) for forming a negative-electrode including the SBS, respectively;

FIG. 3G shows an SEM image of a self-standing film for a negative-electrode of a lithium secondary battery according to Comparative Example 1;

FIG. 3H shows a network structure composed of a binder and a negative-electrode active material in the self-standing film for the negative-electrode of the lithium secondary battery according to Comparative Example 1; and

FIG. 3I and FIG. 3J show SEM images of a self-standing film for a negative-electrode of a lithium secondary battery according to Comparative Example 2.

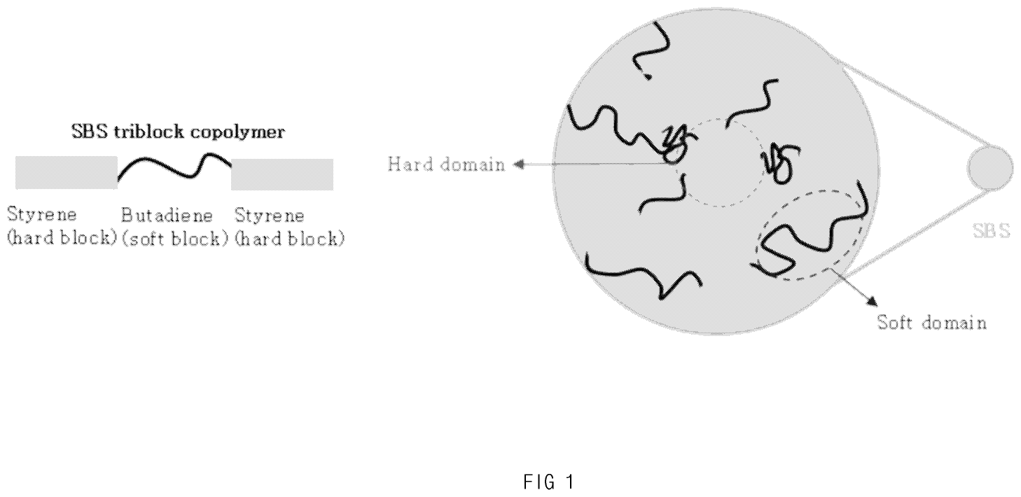

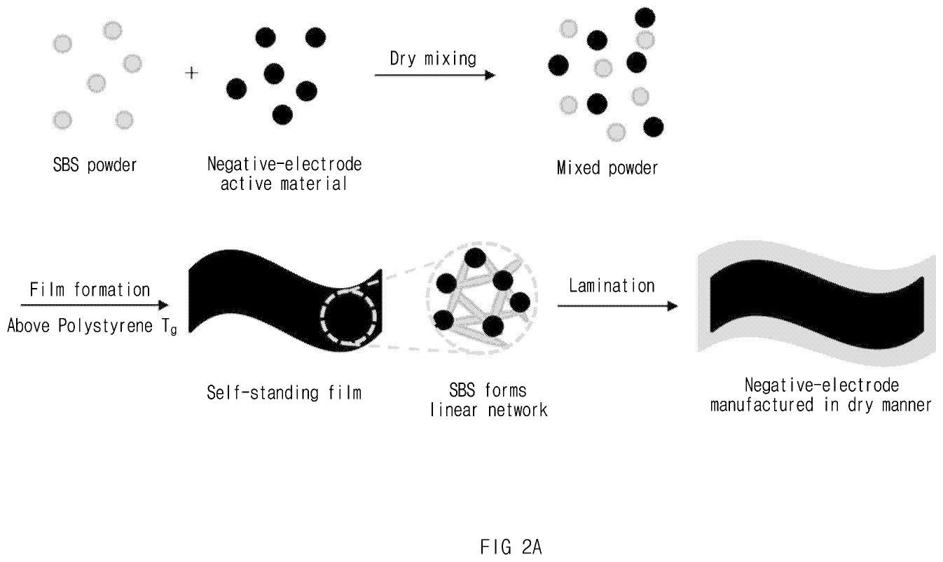

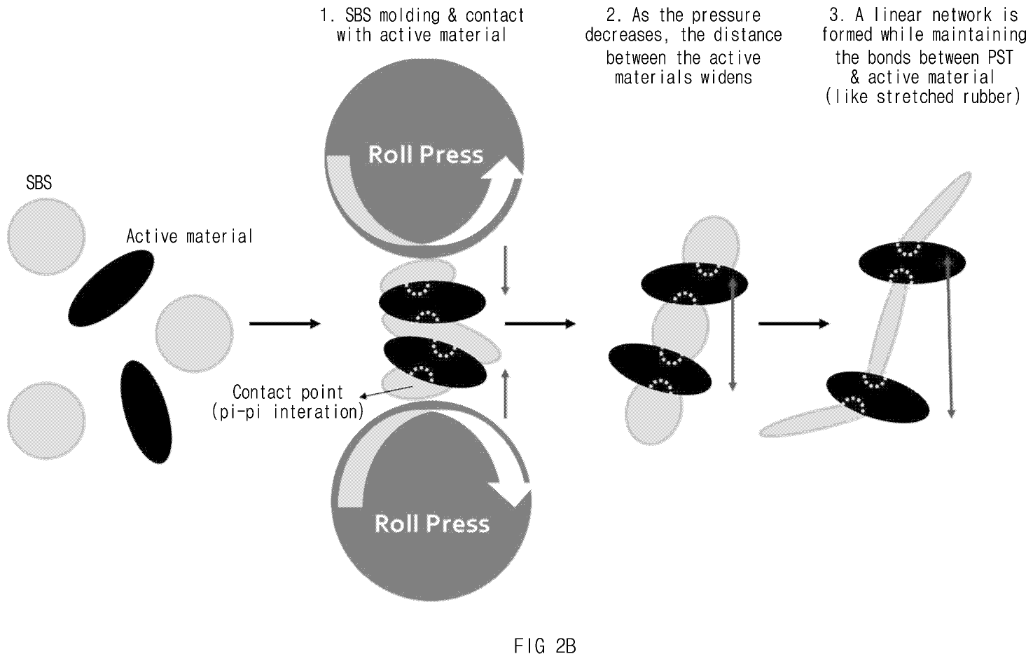

### DETAILED DESCRIPTION

Above objectives, other objectives, features, and advantages of the present disclosure will be readily understood from the following preferred embodiments associated with the accompanying drawings. However, the present disclosure is not limited to the embodiments described herein and may be embodied in other forms. The embodiments described herein are provided so that the disclosure can be made thorough and complete and that the spirit of the present disclosure can be fully conveyed to those skilled in the art. Throughout the drawings, like elements are denoted by like reference numerals. In the accompanying drawings, the dimensions of the structures are larger than actual sizes for clarity of the present disclosure. Terms used in the specification, “first”, “second”, etc., may be used to describe various components, but the components are not to be construed as being limited to the terms. These terms are used only for the purpose of distinguishing a component from another component. For example, without departing from the scope of the present disclosure, a first component may be referred as a second component, and a second component may be also referred to as a first component. As used herein, the singular forms “a”, “an”, and “the” are intended to include the plural forms as well unless the context clearly indicates otherwise. It will be further understood that the terms “comprises”, “includes”, or “has” when used in this specification specify the presence of stated features, regions, integers, steps, operations, elements and/or components, but do not preclude the presence or addition of one or more other features, regions, integers, steps, operations, elements, components and/or combinations thereof. It will also be understood that when an element such as a layer, film, area, or sheet is referred to as being “on” another element, it can be directly on the other element, or intervening elements may be present therebetween. Similarly, when an element such as a layer, film, area, or sheet is referred to as being “under” another element, it can be directly under the other element, or intervening elements may be present therebetween. Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In certain preferred aspects, a vehicle may be electric-powered, including a hybrid vehicles, plug-in hybrids, or vehicles where electric power is the primary or sole power source.

Hereinafter, a method for manufacturing a self-standing film for a negative-electrode of a lithium secondary battery and a self-standing film for a negative-electrode of a lithium secondary battery manufactured using the method will be described in detail such that the skilled person to the art may easily implement the method and the self-standing film.

As a way to reduce the manufacturing cost of the lithium secondary batteries, research on the electrode manufacturing process in a dry manner has been actively conducted. Representatively, there is a technology for manufacturing, in a dry manner, a positive-electrode of a lithium secondary battery using polytetrafluoroethylene (PTFE). PTFE has a low LUMO (lowest unoccupied molecular orbitals) level and may easily accept electrons, and thus is electrochemically unstable in a negative potential environment. Thus, the negative-electrode of the lithium secondary battery manufactured using the PTFE as a binder has poor cycle stability. In addition, when manufacturing the negative-electrode using PTFE, an initial efficiency of the lithium secondary battery deteriorates due to decomposition of the PTFE binder during initial charging.

Accordingly, the present inventors have studied a binder that may be electrochemically stable even at negative potentials and a manufacturing method of the electrode using the same. Finally, we have invented a scheme in which a self-standing film for a negative-electrode is able to be manufactured in a dry manner as described below,

A method for manufacturing a self-standing film for a negative-electrode of a lithium secondary battery according to one embodiment of the present disclosure includes forming a negative-electrode active material layer in a film formation process using a composition for forming the negative-electrode of the lithium secondary battery, wherein the composition includes a negative-electrode active material, a conductive material, and a binder, wherein the binder includes a triblock copolymer having: a soft block derived from an aliphatic or cycloaliphatic diene-based monomer and having a rubber phase at room temperature; and a first hard block and a second hard block respectively connected to both ends of the soft block, and derived from an aromatic ring-containing ethylenically unsaturated monomer, and having a glass phase at room temperature, wherein the binder includes particles, each having an average diameter (D₅₀) in a range of 1 μm inclusive to 50 μm inclusive.

In this regard, the average diameter (D₅₀) of the binder refers to a diameter equivalent to a cumulative 50% of a cumulative volume distribution measured with a laser diffraction/scattering particle size distribution measuring device.

The soft block may contain a repeating unit derived from an aliphatic diene-based monomer and/or an alicyclic diene-based monomer and have a rubber phase at room temperature. Specifically, the soft block may be derived from an aliphatic diene-based monomer including at least one selected from a group consisting of butadiene-based monomer, pentadiene-based monomer, and hexadiene-based monomer.

The butadiene-based monomer may include at least one selected from a group consisting of 1,2-butadiene, 1,3-butadiene, isoprene, and chloroprene.

The pentadiene-based monomer may include at least one selected from a group consisting of 1,2-pentadiene, 1,3-pentadiene, 1,4-pentadiene, 2,3-pentadiene, 2-methyl-1,3-pentadiene, 2-methyl-1,4-pentadiene, 2-methyl-2,3-pentadiene, 2-methyl-2,4-pentadiene, 3-methyl-1,3-pentadiene, 3-methyl-1,4-pentadiene, 4-methyl-1,3-pentadiene, 2-ethyl-1,3-pentadiene, 2-ethyl-1,4-pentadiene, 2-ethyl-2,4-pentadiene, 3-ethyl-1,3-pentadiene, 3-ethyl-1,4-pentadiene, 4-ethyl-1,3-pentadiene, 1-chloro-1,3-pentadiene, 1-chloro-2,4-pentadiene, 2-chloro-1,3-pentadiene, 3-chloro-1,3-pentadiene, 3-chloro-1,4-pentadiene, and 5-chloro-1,3-pentadiene.

The hexadiene-based monomer may include at least one selected from a group consisting of 1,2-hexadiene, 1,3-hexadiene, 1,4-hexadiene, 1,5-hexadiene, 2,3-hexadiene, 2,4-hexadiene, 2,5-hexadiene, 3,5-hexadiene, 2-methyl-1,3-hexadiene, 2-methyl-1,4-hexadiene, 2-methyl-1,5-hexadiene, 2-methyl-2,3-hexadiene, 2-methyl-2,4-hexadiene, 3-methyl-1,2-hexadiene, 3-methyl-1,3-hexadiene, 3-methyl-1,4-hexadiene, 3-methyl-1,5-hexadiene, 3-methyl-2,4-hexadiene, 3-methyl-2,5-hexadiene, 4-methyl-1,3-hexadiene, 4-methyl-1,4-hexadiene, 4-methyl-2,3-hexadiene, 5-methyl-1,3-hexadiene, 5-methyl-1,4-hexadiene, 2-ethyl-1,3-hexadiene, 2-ethyl-1,4-hexadiene, 3-ethyl-1,2-hexadiene, 3-ethyl-1,3-hexadiene, 3-ethyl-1,4-hexadiene, and 3-ethyl-1,5-hexadiene.

The triblock copolymer including the soft block has the characteristics of excellent flexibility, extrusion formability, and wear resistance.

The first hard block and the second hard block may contain a repeating unit derived from an ethylenically unsaturated monomer containing an aromatic ring, and have a glass phase at room temperature. Specifically, the aromatic ring contained in the ethylenically unsaturated monomer may be a substituted or unsubstituted benzene ring or a substituted or unsubstituted naphthalene ring.

Furthermore, the aromatic ring may be connected to a main chain or a side chain of the repeating unit of each of the first hard block and the second hard block, and may be preferably connected to the side chain of the repeating unit of each of the first hard block and the second hard block.

Each of the first hard block and the second hard block may independently be derived from an aromatic ring-containing ethylenically unsaturated monomer including at least one of a styrene-based monomer and an aromatic (meth)acrylic-based monomer.

The styrene-based monomer may include at least one selected from a group consisting of styrene, α-methylstyrene, p-methylstyrene, p-methoxystyrene, p-ethoxystyrene, t-butoxystyrene, p-acetoxystyrene, p-chlorostyrene, p-brom ostyrene, 2,4-dimethylstyrene, 3,5-dimethylstyrene and 2,4,6-trimethylstyrene.

The aromatic (meth)acrylic-based monomer may include at least one selected from a group consisting of benzyl acrylate, benzyl methacrylate, phenoxyacrylate, phenoxymethacrylate, phenyl acrylate, phenyl methacrylate, phenylethyl acrylate, and phenylethyl methacrylate.

Each of the first hard block and the second hard block may strongly bind to the negative-electrode active material or the conductive material via pi-pi interaction due to the aromatic ring structure included in the repeating unit thereof. Furthermore, each of the first hard block and the second hard block may form a crosslink due to physical bonding with a relatively low binding energy, and thus, may maintain a shape and a size thereof at a temperature below the glass transition temperature, while the forming thereof may be easy at a temperature above the glass transition temperature. Accordingly, when manufacturing the self-standing film for the negative-electrode at a temperature at which the triblock copolymer can be formed, the triblock copolymer may be flexibly deformed while each of the hard blocks included in the triblock copolymer maintains the bond with the negative-electrode active material or the conductive material. Thus, a binder portion may provide a physical cross-linking point in a linear form (discontinuous pillar or wire form), such that a solid three-dimensional network structure may be formed around the point.

Furthermore, the first hard block and the second hard block may impart high strength properties to the triblock copolymer containing the same.

A content of the first hard block and the second hard block may be in a range of 10 to 60% by weight, preferably 15 to 55% by weight, and more preferably 20 to 50% by weight, based on a total content of the triblock copolymer. When the content of the first hard block and the second hard block satisfies the above numerical range, the bonding strength may be further improved due to strong interaction thereof with the negative-electrode active material or the conductive material, and the triblock copolymer may have appropriate flexibility and thus may have excellent formability.

A weight average molecular weight of each of the first hard block and the second hard block may be in a range of 9,000 g/mol inclusive to 20,000 g/mol inclusive, preferably 9,500 g/mol inclusive to 20,000 g/mol inclusive, more preferably 10,000 g/mol inclusive to 20,000 g/mol inclusive. When the weight average molecular weight of each of the first hard block and the second hard block satisfies the above numerical range, a physical cross-linking power between the binder and the negative-electrode active material or the conductive material may be improved, allowing a more stable three-dimensional network to be formed, and the processability may be further improved due to easy deformation in manufacturing the electrode.

Each of a first glass transition temperature and a second glass transition temperature corresponding to the first hard block and the second hard block, respectively, may be in a range of 50° C. inclusive to 120° C. inclusive. A third glass transition temperature corresponding to the soft block may be in a range of −120° C. inclusive to −50° C. inclusive. Preferably, each of the first glass transition temperature and the second glass transition temperature may be in a range of 80° C. inclusive to 120° C. inclusive, and the third glass transition temperature may be in a range of −120° C. inclusive to −80° C. inclusive. More preferably, each of the first glass transition temperature and the second glass transition temperature may be in a range of 80° C. inclusive to 110° C. inclusive, and the third glass transition temperature may be in a range of −110° C. inclusive to −80° C. inclusive. As the first hard block, the second hard block, and the soft block included in the triblock copolymer have the glass transition temperatures within the above numerical ranges, not only more reversible formation of the composition for the formation of the negative-electrode of the lithium secondary battery containing the binder including the triblock copolymer may be achieved, but also durability and flexibility of the electrode made of the above composition may be further improved and a shape thereof may be maintained more effectively.

The soft block, the first hard block, and the second hard block included in the triblock copolymer may not affect each other and may exhibit independent properties. Thus, the soft block may independently provide flexibility to the finally formed self-standing film for the negative-electrode of the lithium secondary battery, while the first hard block and the second hard block may independently provide the strong bonding force with the negative-electrode active material to the finally formed self-standing film for the negative-electrode of the lithium secondary battery. Furthermore, the soft block and the hard blocks have different glass transition temperatures. Thus, when the self-standing film for the negative-electrode is formed (via calendering, etc.) at a temperature above the glass transition temperature of the hard block, the formability of the triblock copolymer becomes good. Immediately after the film formation, exposure to a temperature below the glass transition temperature of the hard block and above the glass transition temperature of the soft block may allow the triblock copolymer to be flexible and maintain the high strength, so that the self-standing film for the negative-electrode of the lithium secondary battery including the triblock copolymer may not be easily broken by external stimuli.

The triblock copolymer is stable at a negative potential, so that occurrence of side reactions is suppressed. Thus, when the triblock copolymer is used as the binder for the negative-electrode of the lithium secondary battery, the lifespan characteristics of the electrode may be improved.

The binder may be substantially spherical, and may have a spherical or substantially a spherical shape, and specifically, its average sphericity may be in a range of 0.7 to 1.0, preferably 0.8 to 1.0, more preferably 0.9 to 1.0. In other words, each of the binder particles in the composition for forming the negative-electrode of the lithium secondary battery including the binder before manufacturing the self-standing film for the negative-electrode may remain substantially in a spherical shape and may be dispersed in the composition for formation of the negative-electrode.

In this regard, the sphericity of the binder may be derived as follows: major and minor diameters of 10 randomly selected particles using images of binder particles observed with a scanning electron microscope (SEM), and a ratio of the minor axis/major diameters of each particle may be obtained, and then, an average value of the ratios of the minor and major diameters may be defined as the sphericity. As the sphericity is closer to 1, a shape of the particle may be closer to the spherical shape.

The negative-electrode active material may include at least one selected from a group consisting of carbon-based active material, silicon-based active material, metal-based active material capable of being alloyed with lithium, and lithium-containing active material.

The carbon-based active material may be, for example, graphite, hard carbon, soft carbon, or graphene. The graphite may be artificial graphite, natural graphite, a mixture of artificial graphite and natural graphite, natural graphite coated with artificial graphite, or a combination thereof.

The carbon-based active material has a small change in a crystal structure during intercalation/de-intercalation of lithium ions, thereby enabling continuous and repetitive redox reactions at the electrode, thereby realizing a lithium secondary battery with high capacity and better lifespan.

The silicon-based active material may be, for example, Si, SiOₘ, Si—C composite, Si-Q alloy, or a combination thereof, where m is 0<m≤2, and Q is an alkali metal, alkali earth metal, a group 13 to group 16 element, a transition metal, a rare earth element, or a combination thereof, and Si is excluded from Q.

The metal-based active material that can be alloyed with lithium may include, for example, B, Al, Ga, In, Ge, Sn, Pb, P, As, Sb, Bi, Mg, Ca, Zn, Cd, Pd, Ag, Au, Pt, alloys thereof, or oxides thereof.

The lithium-containing active material may be, for example, lithium-containing titanium complex oxide (LTO).

The conductive material may include at least one selected from a group consisting of graphite, activated carbon, carbon black, acetylene black, Ketjen black, carbon nanotubes, graphene, and carbon fiber.

The film formation process may be performed in a dry manner. In other words, the composition for forming the negative-electrode of the lithium secondary battery used in the film formation process may not substantially include a solvent. When the film formation process is performed in a wet manner, there is a limitation in increasing a loading amount of the electrode due to the liquid slurry, and a network structure between the binder and the active material/conductive material cannot be formed. However, according to the present disclosure, the film formation process is performed in the dry manner, thereby enabling a great electrode loading amount that realizes a high energy density, and thereby manufacturing the lithium secondary batteries in which the network structure between the binder and the active material is formed more effectively.

The film formation process may include calendering (rolling). The term calendering as used herein refers to a trolling process as is well understood by those in the art. In other words, the negative-electrode active material layer may be formed by passing the composition for forming the negative-electrode of the lithium secondary battery, including the negative-electrode active material, the conductive material, and the binder between a pair of rolls and pressing and rolling the composition therebetween. In this regard, a diameter of the roll may be, for example, 50 to 1000 mm, preferably 100 to 1000 mm, and more preferably 100 to 500 mm.

The calendering may be performed at a temperature equal to or higher than the first glass transition temperature and the second glass transition temperature corresponding to the first hard block and the second hard block, respectively. Specifically, the calendaring may be carried out at 50 to 140° C., preferably at 80 to 140° C., and more preferably at 80 to 130° C. Accordingly, the formability of the triblock copolymer including the first hard block and the second hard block and the binder including the same may be further improved.

External forces such as shear force and tension force may be applied to the composition via the calendaring, thereby finally manufacturing the self-standing film for the negative-electrode of the lithium secondary battery.

Specifically, the negative-electrode active material layer manufactured in a dry manner may be a free-standing negative-electrode active material layer. The free-standing negative-electrode active material layer refers to a negative-electrode active material layer in a form of a thin film or film that maintains a certain shape by itself without being supported by another substrate. The free-standing negative-electrode active material layer may be manufactured in this way, such that a subsequent lamination process may proceed smoothly.

An average thickness of the self-standing film manufactured in this way may be in a range of 30 μm inclusive to 500 μm inclusive, preferably 50 μm inclusive to 300 μm inclusive, and more preferably 70 μm inclusive to 200 μm inclusive.

According to another embodiment of the present disclosure, provided is a self-standing film for a negative-electrode of a lithium secondary battery, wherein the self-standing film includes a negative-electrode active material layer including a plurality of domains of a negative-electrode active material, a plurality of domains of a conductive material, and a binder, wherein the binder includes a triblock copolymer having: a soft block derived from an aliphatic or cycloaliphatic diene-based monomer and having a rubber phase at room temperature; and a first hard block and a second hard block respectively connected to both ends of the soft block, derived from an aromatic ring-containing ethylenically unsaturated monomer, and having a glass phase at room temperature, wherein the binder has a discontinuous pillar connecting one domain of the active material or one domain of the conductive material to another domain of the active material or another domain of the conductive material.

The same contents as previously described in the method for manufacturing the self-standing film for the negative-electrode of the lithium secondary battery may be applied to the triblock copolymer including the soft block, the first hard block, and the second hard block.

One domain of the active material or one domain of the conductive material and another domain of the active material or another domain of the conductive material may be connected to each other via the binder in the form of the discontinuous pillar (or a wire) to form the three-dimensional network. In other words, the binder in the form of a non-continuous pillar (or wire) connects an outer surface of one domain of the active material or an outer surface of one domain of the conductive material with an outer surface of another domain of the active material or an outer surface of another domain of the conductive material to form a complex of the three-dimensional network structure in a net shape (the active material or the conductive material is located at an intersection and the linear binder connects them to each other). This three-dimensional network may be due to strong pi-pi interaction between the first hard block and the second hard block included in the triblock copolymer and the negative-electrode active material or the conductive material.

Specifically, during the film formation process, contact occurs between the binder including the triblock copolymer and the negative-electrode active material or the conductive material due to high external force (shear force or tensile force, etc.). Afterwards, as the external force is lowered at an end of the film formation process, a distance between the binder and the negative-electrode active material or the conductive material increases, such that while the binder including the triblock copolymer in contact with the surface of the negative-electrode active material or the conductive material maintains the bond therewith, the shape of the binder may be flexibly deformed into the discontinuous pillar or wire form.

Furthermore, the triblock copolymer may change into the pillar shape under pressure at the temperature at which the film formation process is performed, thereby forming the three-dimensional network. As described above, the domain of the active material or the domain of the conductive material and the binder in the form of the discontinuous pillar may be connected to each other to form the three-dimensional network, thereby making it possible to manufacture the negative-electrode of the lithium secondary battery with excellent tensile strength.

An average width of the binder perpendicular to its longitudinal direction may be in a range of 0.2 μm inclusive to 2 μm inclusive, preferably 0.2 μm inclusive to 0.8 μm inclusive, and more preferably 0.3 μm inclusive to 0.7 μm inclusive.

In this regard, the average width perpendicular to the longitudinal direction of the pillar-shaped binder included in the self-standing film may be derived as follows: a width perpendicular to the longitudinal direction at each of both ends and a center along the longitudinal direction of each of five randomly selected pillar binders was measured using the image of the binder particle observed with a scanning electron microscope (SEM), and an average value of these measured values is defined as the average width.

The average thickness of the self-standing film may be in a range of 30 μm inclusive to 500 μm inclusive, preferably 50 μm inclusive to 300 μm inclusive, more preferably 70 μm inclusive to 200 μm inclusive.

The tensile strength of the self-standing film may be in a range of 0.5 MPa or greater, preferably 0.7 MPa or greater, and more preferably 1.0 MPa or greater.

According to still another embodiment of the present disclosure, a negative-electrode for a lithium secondary battery including a current collector; and the self-standing film for the negative-electrode of the lithium secondary battery disposed on the current collector is provided.

When the self-standing film for the negative-electrode of the lithium secondary battery is formed via the film formation process, the self-standing film may be placed on the current collector and may be subjected to lamination. The lamination may be performed by a lamination roll, and in this regard, the lamination roll may be maintained at a temperature of 80° C. to 200° C. Via this lamination process, the self-standing film and current collector for the negative-electrode of the lithium secondary battery may be bonded to each other.

The current collector is not particularly limited as long as it has high conductivity without causing chemical changes in the battery. For example, stainless steel, aluminum, nickel, titanium, calcined carbon, copper, aluminum, or alloys thereof, or stainless steel having a surface treated with carbon, nickel, titanium, silver, etc. may be used as the current collector.

According to still another embodiment of the present disclosure, a lithium secondary battery including the negative-electrode for the lithium secondary battery; a positive-electrode for the lithium secondary battery; and an electrolyte is provided.

The positive-electrode for the lithium secondary battery may include at least one positive-electrode active material selected from a group consisting of lithium, nickel, cobalt, manganese, iron, tin, silicon, aluminum, and mixtures thereof. In a specific example, the positive-electrode active material such as LiCoO₂, LiMnO₂, LiFeO₂, Li(Ni_{0.6}(Mn_{0.2}Co_{0.2}) O₂, Li(Ni_{0.7}Mn_{0.15}C_{0.15}) O₂, Li(Ni_{0.8}Mn_{0.1}Co_{0.1})O₂, Li(Ni_{0.9}Mn_{0.9}O_{0.05}Co_{0.05}) O₂, LiNi_{0.6}Co_{0.2}0Al_{0.2}O₂, LiNi_{0.7}Co_{0.2}Al_{0.1}O₂, LiNi_{0.6}Co_{0.15}Al_{0.05}O₂, LiNin_{0.85}Co_{0.1}AlA_{0.05}O₂, LiNi_{0.88}Co_{0.1}Al_{0.02}O₂, LiMn₂O₄, LiFePO₄, etc. may be used for the positive-electrode for the lithium secondary battery.

The electrolyte may be a liquid electrolyte or a solid electrolyte.

When the electrolyte is the liquid electrolyte, the electrolyte may include lithium salt and a non-aqueous organic solvent.

The lithium salt may be applied without limitation as long as it is commonly used in the electrolyte of the lithium secondary batteries. For example, the lithium salt may include at least one compound selected from a group consisting of LiPF₆, LiBF₄, LiSbF₆, LiAsF₆, LiN(C₂F₅SO₂)₂, LiN(CF₃SO₂)₂, CF₃SO₃Li, LiC(CF₃SO₂)₃, LiC₄BO₈, LiTFSI, LiFSI and LiClO₄.

The non-aqueous organic solvent may include a type of organic solvent that may be used as a non-aqueous electrolyte in manufacturing the conventional lithium secondary battery. In this regard, a content thereof may also be appropriately changed within a generally usable range.

Specifically, the non-aqueous organic solvent may include common organic solvents that may be used as non-aqueous organic solvents for lithium secondary batteries, such as cyclic carbonate solvents, linear carbonate solvents, ester solvents, or ketone solvents. The common organic solvents may be used alone as well as in a mixture of at least two species thereof.

The cyclic carbonate solvent may include at least one selected from a group consisting of ethylene carbonate (EC), vinylene carbonate (VC), fluoroethylene carbonate (FEC), propylene carbonate (PC), and butylene carbonate (BC).

The linear carbonate solvent may include at least one selected from a group consisting of dimethyl carbonate (DMC), diethyl carbonate (DEC), dipropyl carbonate (DPC), ethylmethyl carbonate (EMC), methylpropyl carbonate (MPC), and ethylpropyl carbonate (EPC).

The ester solvent may include at least one selected from a group consisting of methyl acetate, ethyl acetate, propyl acetate, methyl propionate, ethyl propionate, γ-butyrolactone, γ-valerolactone, γ-caprolactone, δ-valerolactone and ε-caprolactone.

Polymethylvinyl ketone, etc. may be used as the ketone solvent.

When the electrolyte is the liquid electrolyte, the lithium secondary battery may further include a separator.

The separator may include one or a stack of commonly used porous polymer films, for example, porous polymer films respectively made of polyolefin-based polymers such as ethylene homopolymer, propylene homopolymer, ethylene/butene copolymer, ethylene/hexene copolymer, and ethylene/methacrylate copolymer. Alternatively, a typical porous nonwoven fabric, for example, a nonwoven fabric made of high melting point glass fibers or polyethylene terephthalate fibers may be used as the separator. However, the present disclosure is not limited thereto. Furthermore, the separator coated with a ceramic component or a polymer material may be used to ensure heat resistance or mechanical strength. Optionally, the separator may have a single-layer or multi-layer structure.

In this regard, a pore diameter of the porous separator may be generally in a range of 0.01 to 50 μm, and a porosity thereof may be in a range of 5 to 95%. Furthermore, a thickness of the porous separator may generally range from 5 to 300 μm.

In one example, when the electrolyte is the solid electrolyte, the electrolyte may be a polymer-based solid electrolyte, an oxide-based solid electrolyte, a sulfide-based solid electrolyte, or a mixture thereof.

The polymer solid electrolytes may include, for example, polyether-based polymers, polycarbonate-based polymers, acrylate-based polymers, polysiloxane-based polymers, phosphazene-based polymers, polyethylene derivatives, alkylene oxide derivatives such as polyethylene oxide, phosphate ester polymer, poly agitation lysine, polyester sulfide, polyvinyl alcohol, polyvinylidene fluoride and its derivatives, polymers containing ionic dissociation groups, etc. Furthermore, the polymer electrolyte may include, as a polymer resin, a branched copolymer in which amorphous polymers such as PMMA, polycarbonate, polysiloxane, and/or phosphazene are copolymerized with a PEO (polyethylene oxide) main chain, a comb-like polymer, and a cross-linked polymer resin, etc. The polymer electrolyte may include as least one type thereof. The oxide-based solid electrolyte may include, for example, LLZO-based compounds, LLTO-based compounds such as Li₃ₓLa_{2/3-X}TiO₃, LISICON-based compounds such as Li₁₄Zn(GeO₄)₄, LATP-based compounds such as Li_{1.3}Al_{0.3}Ti_{1.7}(PO₄)₃, LAGP-based compounds such as (Li₁₊ₓGe₂₋ₓAlₓ(PO₄)₃), and LIPON-based compounds, etc. However, the present disclosure is not particularly limited thereto.

The sulfide-based solid electrolyte may include at least one of Li₆PS₅Cl, Li₂S—P₂S₅, Li₂S—LiI—P₂S₅, Li₂S—LiI—Li₂O—P₂S₅, Li₂S—LiBr—P₂S₅, Li₂S—Li₂O—P₂S₅, Li₂SLi₃PO₄—P₂S₅, Li₂S—P₂S₅—P₂O₅, Li₂S—P₂S₅—SiS₂, Li₂S—P₂S₅—SnS, Li₂S—P₂S₅—Al₂S₃, Li₂S—GeS₂ or Li₂S—GeS₂—ZnS. However, the present disclosure is not particularly limited thereto.

Hereinafter, the present disclosure is described in more detail based on Examples. However, these Examples are only intended to help understand the present disclosure, and the scope of the present disclosure is not limited to these Examples in any way.

### <Present Example 1> Manufacturing 1 of Self-Standing Film for Negative-Electrode

First, graphite as a negative-electrode active material, carbon as a conductive material, and SBS triblock copolymer (glass transition temperature of polystadien block: 100° C., glass transition temperature of polybutadiene block: −100° C.) as a binder were mixed with each other at a mass ratio of 96:1:3 without a solvent. The mixed powders were rolled using a two-roll press heated to 120° C. to manufacture a self-standing film.

### <Comparative Example 1> Manufacturing 2 of Self-Standing Film for Negative-Electrode

A self-standing film for the negative-electrode was manufactured in the same manner as Present Example 1, except that PTTF was used instead of SBS as the binder and the mixed powder was rolled using a two-roll press heated to 80° C.

### <Comparative Example 2> Manufacturing of SBR Negative-Electrode Coating Layer

We dissolved 5.8 g of CMC (Carboxymethyl cellulose) in 255.5 g of distilled water and stirred the mixture at a speed of 500 rpm for 12 hours. Next, we added, thereto, 17.5 g of aqueous solution in which 40% by weight SBR (Styrene-Butadiene Rubber) was dissolved in distilled water, and stirred the mixture for an additional 6 hours to dissolve the whole amount. Thus, a CMC/SBR (1/1.2) binder dispersion in which 5 parts by weight of CMC/SBR was dissolved in 100 parts by weight of the solution was synthesized.

Next, graphite as a negative-electrode active material, carbon as a conductive material, and the CMC/SBR binder dispersion were mixed with each other at a mass ratio of 96.8:1:2.2, and the mixed slurry was applied on copper so as to have a thickness of about 100 μm and was dried at 120° C.

### <Experimental Example 1> SEM Image Observation of Self-Standing Film for Negative-Electrode

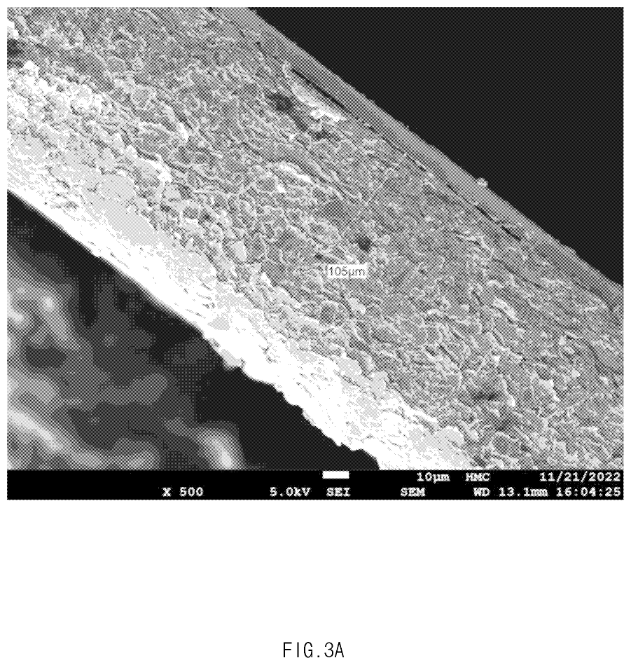

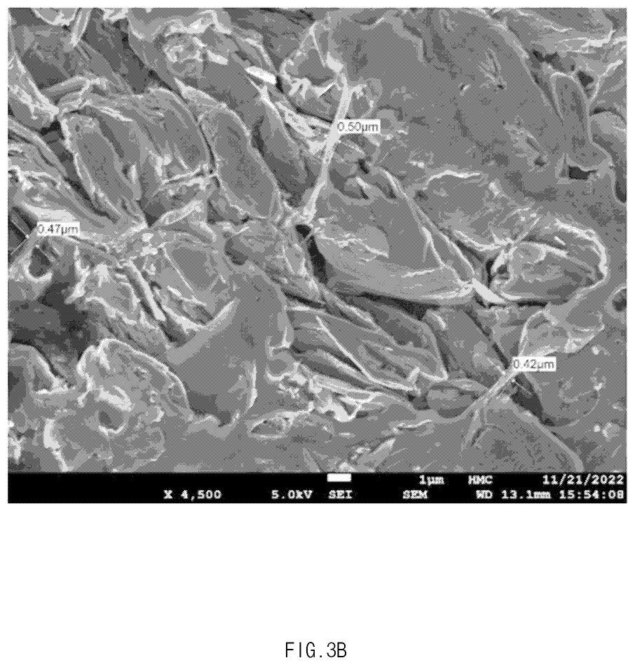

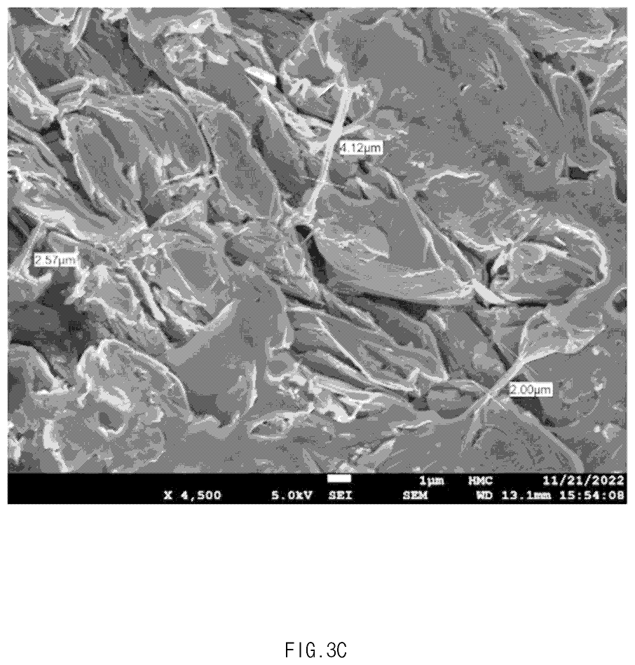

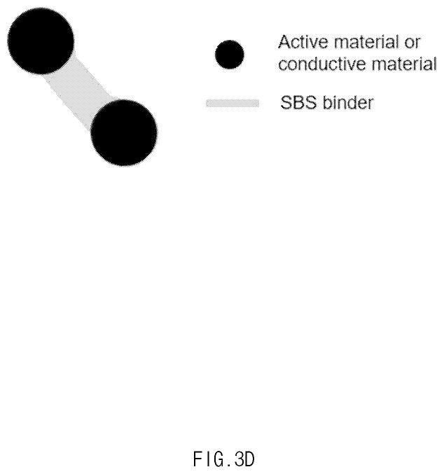

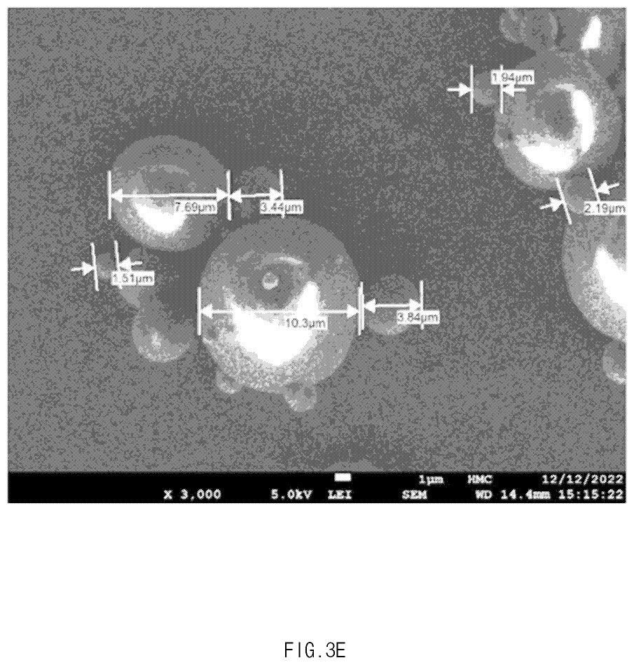

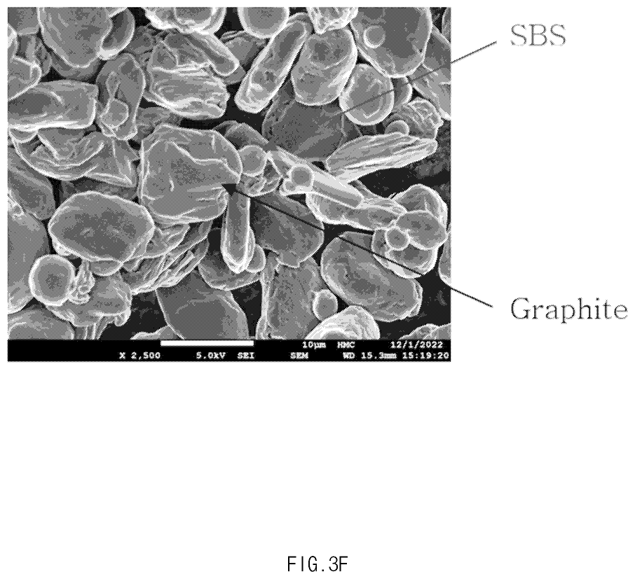

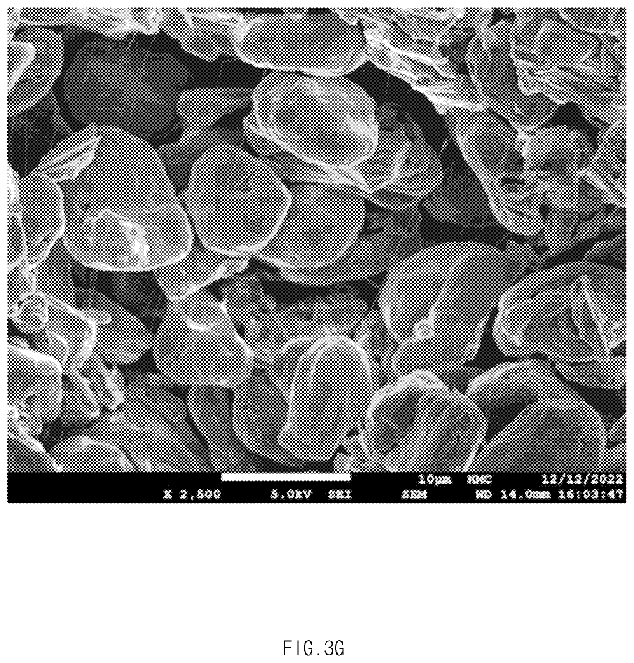

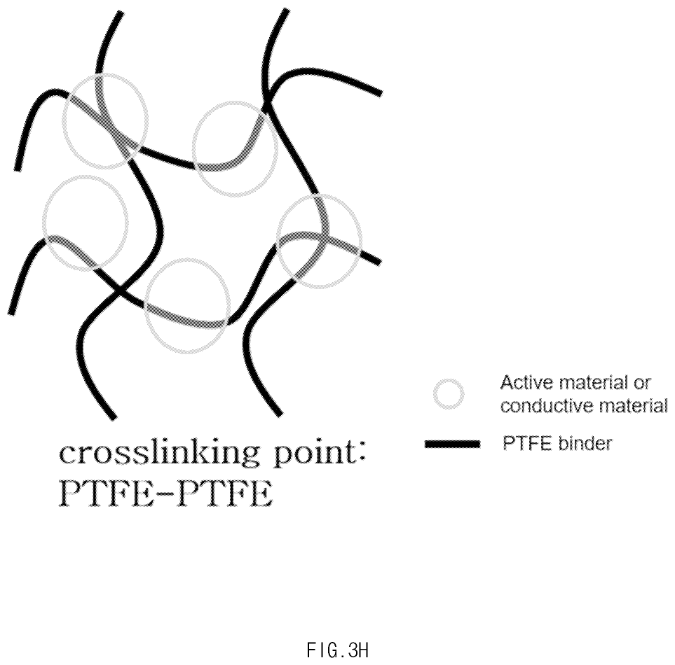

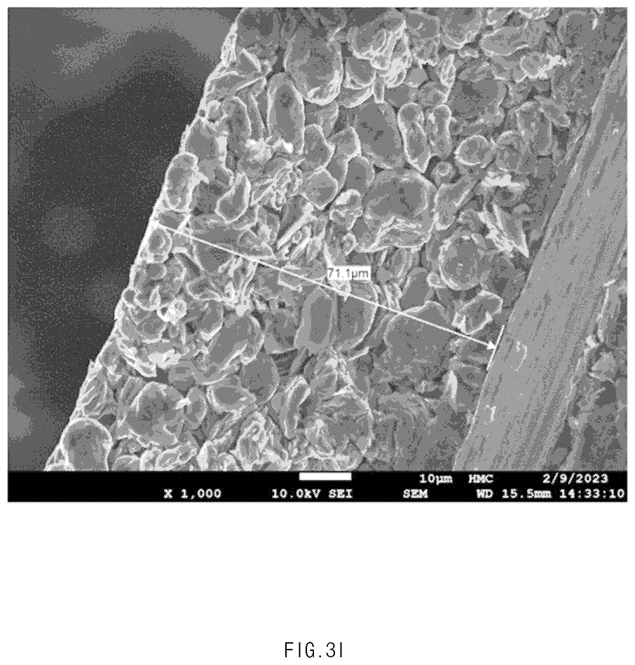

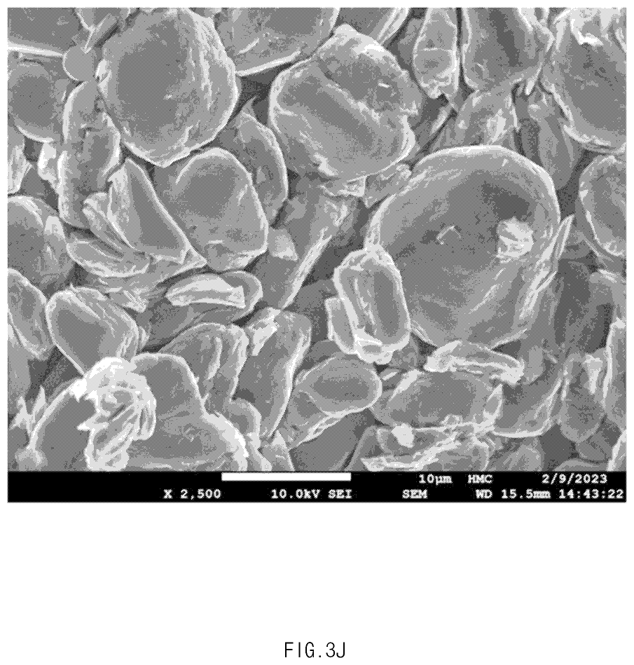

SEM images were taken of the self-standing film for the negative-electrode manufactured according to Present Example 1 and are shown in FIG. 3A to FIG. 3C. Further, in order to prepare for change in the shape of the binder after the film formation process, SEM images were taken of an initial SBS binder, and the mixed powder of the graphite, the conductive material, and the binder before the film formation process, and are shown in FIG. 3D and FIG. 3E. Furthermore, SEM images of the self-standing films for the negative-electrode manufactured according to Comparative Example 1 and Comparative Example 2 are shown in FIG. 3F to FIG. 3H.

Referring to FIG. 3A, it was identified that a thickness of the self-standing film for the negative-electrode formed via the film formation process was about 105 μm.

FIG. 3B and FIG. 3C, it may be identified that after the film formation process, the SBS binder of the pillar connects the negative-electrode active materials to each other, the conductive materials to each other, or the negative-electrode active material and the conductive material to each other to form a network structure, and is in the form of the pillar with the average width perpendicular to its longitudinal direction in a range of about 0.4 to 0.5 μm.

FIG. 3D schematically shows the pillar-shaped SBS binder that connects the negative-electrode active materials to each other in the network structure of the self-standing film for the negative-electrode manufactured according to Present Example 1. In other words, it may be identified that the discontinuous SBS binder in the form of the pillar point-contacts the outer surface of each of the active material domains or the conductive material domains, thereby connecting them to each other.

In one example, FIG. 3E shows an SEM image of the SBS powder before preparing the composition for forming the negative-electrode. It may be identified that the SBS powder is almost spherical. FIG. 3F is an SEM image of the composition for forming the negative-electrode (powder mixture of negative-electrode active material, conductive material, and SBS binder before the film formation process). It may be identified that the SBS binder is dispersed while maintaining an almost spherical shape (the average diameter (D₅₀): 8 μm, the average sphericity: 0.95).

Referring to FIG. 3G, it may be identified that, unlike the case of Present Example 1, in the case of the PTFE binder, a three-dimensional network in which the discontinuous pillar-shaped binder connects the active materials or the conductive materials to each other is not formed.

FIG. 3H schematically shows the network structure in the self-standing film for the negative-electrode according to Comparative Example 1. In the case of Comparative Example 1, a structure in which the binder and the negative-electrode active material are connected to each other as in Present Example 1 is not present, but the PTFE binders are connected to each other to form a network structure, and the negative-electrode active materials are positioned so as to randomly overlapping on top of the network structure without any point contact (a portion visible as faint lines partially hidden with the active material particles corresponds to the network structure of the PTFE binder).

Referring to FIG. 3I and FIG. 3J, it may be identified that when manufacturing the electrode using an SBR binder in a wet manner, the three-dimensional network due to the binder in the form of the pillar is not observed.

### <Experimental Example 2> Measurement of Tensile Strength of Self-Standing Film for Negative-Electrode

To evaluate the tensile strength of the self-standing film for the negative-electrode manufactured according to each of Present Example 1 and Comparative Example 1, each self-standing film was punched to a size of 2 cm wide and 6 cm long, and then using UTM equipment, the tensile strength thereof was measured at a speed of 5 mm/min.

The tensile strength of the self-standing film for the negative-electrode according to Present Example 1 was 1.06 MPa, and the tensile strength of the self-standing film for the negative-electrode according to Comparative Example 1 was 0.253 MPa. Thus, it was identified that the tensile strength of the self-standing film for negative-electrode according to Present Example 1 using the SBS as the binder was much superior.

This is believed to be because the SBS binder connects the active materials to each other, the conductive materials to each other, or the active material and the conductive material to each other to form the three-dimensional network, thereby exhibiting a strong binding force.

### <Present Example 2> Manufacturing 1 of Lithium Secondary Battery

The self-standing film for the negative-electrode according to Present Example 1 was placed on one surface of a copper foil coated with a primer layer, and was subjected to lamination using a lamination roll maintained at 120° C. Thus, the negative-electrode of the lithium secondary battery was manufactured.

The manufactured negative-electrode, lithium metal as the positive-electrode, and electrolyte in which 1M of LiPFF₆, 2% by weight of vinylene carbonate (VC), and 1% by weight of LiPO₂F₂ were mixed with each other in a solvent in which EC:EMC:DEC were mixed with each other at a volume ratio of 25:45:30 were used to manufacture a coin-type half cell.

### <Comparative Example 3> Manufacturing 2 of Lithium Secondary Battery

A coin-type half cell was manufactured in the same manner as Present Example 2, except that the self-standing film for the negative-electrode according to Comparative Example 1 was used instead of the self-standing film for the negative-electrode according to Present Example 1.

### <Experimental Example 3> Performance Evaluation of Lithium Secondary Battery

One cycle was performed on the lithium secondary battery according to each of Present Example 2 and Comparative Example 3 at a rate of 0.1 C-rate, and the charging capacity and discharging capacity were measured and shown in Table 1 below.

It was identified that the lithium secondary battery according to Present Example 2, that is, the lithium secondary battery using the self-standing film for the negative-electrode according to Present Example 1 exhibited better charge and discharge efficiency. Specifically, it may be identified that in the lithium secondary battery according to Comparative Example 3, a side reaction occurs because the PTFE binder is used, and thus, a relatively large amount of lithium is consumed, so that the charging capacity is higher compared to the lithium secondary battery according to Present Example 2, whereas the overall efficiency thereof is further reduced. On the contrary, the lithium secondary battery according to Present Example 2 exhibits excellent efficiency because the occurrence of the side reactions is suppressed due to the SBS binder.

This is because PTFE has poor stability at negative potentials due to its low LUMO level, thereby causing decomposition and side reactions, while the SBS binder has excellent stability at negative potentials due to its appropriate energy level.

TABLE 1

| | Negative- | | | |
|---|---|---|---|---|
| | electrode | Charging | Discharging | |
| | loading | capacity | capacity | Efficiency |
| Examples | (mg/cm³) | (mAh/g) | (mAh/g) | (%) |
| Present | 26.2 | 387 | 346 | 90 |
| Example 2 | | | | |
| Comparative | 23.9 | 417 | 341 | 82 |
| Example 3 | | | | |

Using the method for manufacturing the self-standing film for the negative-electrode of the lithium secondary battery in accordance with the present disclosure, the binder may bind to the negative-electrode active material or the conductive material via the strong interaction therewith, and thus, the self-standing film for the negative-electrode of the lithium secondary battery which is electrochemically stable even at the negative potential, and has excellent tensile strength and has good formability may be manufactured.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A method for manufacturing a self-standing film suitable for a negative-electrode of a lithium secondary battery, the method comprising:
forming a negative-electrode active material layer using a composition comprising i) a negative-electrode active material, ii) a conductive material, and iii) a binder,
wherein the binder includes a triblock copolymer comprising:
a soft block derived from an aliphatic or cycloaliphatic diene-based monomer and having a rubber phase at room temperature; and
a first hard block and a second hard block respectively connected to ends of the soft block, and derived from an aromatic ring-containing ethylenically unsaturated monomer, and having a glass phase at the room temperature,
wherein the binder includes a plurality of particles each having an average diameter (D₅₀) in a range of 1 μm to 50 μm.

2. The method of claim 1, wherein the binder has a spherical shape, and an average sphericity thereof is in a range of 0.8 to 1.0.

3. The method of claim 1, wherein each of first and second glass transition temperatures corresponding to the first hard block and the second hard block, respectively, is in a range of 50° C. to 120° C., wherein a third glass transition temperature corresponding to the soft block is in a range of −120° C. than −50° C.

4. The method of claim 1, wherein the soft block is derived from an aliphatic diene-based monomer including at least one selected from a group consisting of butadiene-based monomer, pentadiene-based monomer, and hexadiene-based monomer.

5. The method of claim 1, wherein each of the first hard block and the second hard block is independently derived from an aromatic ring-containing ethylenically unsaturated monomer including at least one of a styrene-based monomer and an aromatic (meth)acrylic-based monomer.

6. The method of claim 1, wherein the negative-electrode active material includes at least one selected from a group consisting of carbon-based active material, silicon-based active material, metal-based active material capable of being alloyed with lithium, and lithium-containing active material.

7. The method of claim 1, wherein the conductive material includes at least one selected from a group consisting of graphite, activated carbon, carbon black, acetylene black, Ketjen black, carbon nanotubes, graphene, and carbon fiber.

8. The method of claim 1, wherein the film formation process is performed in a dry manner.

9. The method of claim 6, wherein the film formation process includes calendaring,
wherein the calendering is performed at a temperature equal to or higher than a first glass transition temperature and a second glass transition temperature corresponding to the first hard block and the second hard block, respectively.

10. A self-standing film suitable for a negative-electrode of a lithium secondary battery, the film comprising:
a negative-electrode active material layer that comprises i) a plurality of domains of a negative-electrode active material, ii) a plurality of domains of a conductive material, and iii) a binder,
wherein the binder includes a triblock copolymer having:
a soft block derived from an aliphatic or cycloaliphatic diene-based monomer and having a rubber phase at room temperature; and
a first hard block and a second hard block derived from an aromatic ring-containing ethylenically unsaturated monomer, and having a glass phase at the room temperature,
wherein the binder has a discontinuous pillar connecting i) one domain of the active material or ii) one domain of the conductive material to a) another domain of the active material or b) another domain of the conductive material.

11. The self-standing film of claim 10, wherein the domain of the active material or the domain of the conductive material and the binder in the form of the discontinuous pillar are connected to each other to form a three-dimensional network.

12. The self-standing film of claim 10, wherein the binder has an average width perpendicular to a longitudinal direction thereof in a range of 0.2 μm to 2 μm.

13. The self-standing film of claim 10, wherein each of a first glass transition temperature and a second glass transition temperature corresponding to the first hard block and the second hard block, respectively is in a range of 50° C. to 120° C.,
wherein a third glass transition temperature corresponding to the soft block is in a range of −120° C. to −50° C.

14. The self-standing film of claim 10, wherein the soft block is derived from an aliphatic diene-based monomer including at least one selected from a group consisting of butadiene-based monomer, pentadiene-based monomer, and hexadiene-based monomer.

15. The self-standing film of claim 10, wherein each of the first hard block and the second hard block is independently derived from an aromatic ring-containing ethylenically unsaturated monomer including at least one of a styrene-based monomer and an aromatic (meth)acrylic-based monomer.

16. The self-standing film of claim 10, wherein an average thickness of the self-standing film is in a range of 30 μm to 500 μm.

17. The self-standing film of claim 10, wherein a tensile strength of the self-standing film is 0.5 MPa or greater.

18. A negative-electrode suitable for a lithium secondary battery comprising:
a current collector; and
a self-standing film of claim 10 disposed on the current collector.

19. A lithium secondary battery comprising:
a negative-electrode of claim 18;
a positive-electrode; and
an electrolyte.

20. A vehicle comprising a battery of claim 19.
